(19) United States
(12) Patent Application Publication
(10) Pub. No.: US 2005/0159978 A1
(43) Pub. Date: Jul. 21, 2005

(54) Method of modulating health-care expenses

(76) Inventor: Anuthep Benja-Athon, New York, NY (US)

Correspondence Address: ANUTHEP BENJA-ATHON, M.D.;Pain Management, Acupuncture Physical Therapy, 210 E 36th St., New York, NY, 10016, US

(21) Appl. No.: 10/760,694

(22) Filed: Jan. 21, 2004

(51) Int. Cl. G06F 17/60

(52) U.S. Cl. 705/2

(57) ABSTRACT

A system of empowering a person or a company who is the consumer-buyer of health-care to directly take charge of and exert control on own's health-care utilizations and expenses. The system permits and facilitates a person or a company to use and manipulate the knowledges and data on health-care utilizations and expenses thereby optimizing the utilizations and the returns on the expenses.

### FIELD OF INVENTION

A method for modulating an individual's health-care utilizations and expenses.

### BACKGROUND OF THE INVENTION

U.S. Pat. No. 6,132,218 entitled Images for Communication of Medical Information in Compute granted on Oct. 17, 2000 to this appliant, a pending application entitled the Best American Healthcare System, docket number ABA 208, filed Dec. 17, 2002 and an abandoned application, docket number ABA207, entitled the Best Healthcare System filed Nov. 18, 2002 represent this applicant's continual quest to solve the current health-care crisis and improve people's health, quality of life and standard of living.

Summarily, the current health-care system is primitive and not working. Consequently, to say the least, people are afflicted with pain and suffering. Therefore, one of the several objectives of the present invention is to provide a method comprises processes of fixing the dilapidated health-care system and improving people's health, quality of life and standard of living and saving lives.

### SUMMARY OF THE INVENTION

Although many advances in medicine were achieved, the dilapidated health-care system continue to afflict unnecessary and untold pain and suffering on people whose health, quality of life and standard of living and lives are compromised and jeopardized. Heretofore, no solution was had.

The present invention is a system of empowering a person or a company henceforth also known as entity who is the consumers and buyers of health-cares and health-services to directly take charge of and exert direct and instant control on his, her, their or its health, quality of life, standard of living and performances. Said system comprises a method and processes of using, understanding, applications and manipulations of the knowledges of and data on oneself to achieve the objectives of the present invention.

The system comprises a method of directly modulating, controlling and budgeting the health-care and health-service utilizations and expenses by said entity thereby optimizing said utilizations, expenses by and the returns of said utilizations and expenses to said entity which is a direct consumer-buyer of health-cares, health-services and related procedures, products and services. Since the system relates—by mathetical and statistical means—said health-care and health-service utilizations, expenses and costs to demographics, productivity, impairment, employment and absenteeism characteristics of said entity, consequently, the outcome of the application of said system by said entity is the effects on said entity's health, quality of life, revenues, incomes and standard of living.

### DESCRIPTION OF THE PREFERRED EMBODIMENTS

The present invention is a system of empowering a person, family, dependents, retirees, company or corporation henceforth also known as entity who is the consumers and buyers of health-cares and health-services to directly take charge of and exert direct and instant control on his, her, their or its health, quality of life, standard of living and performances. Said system comprises a method and processes of using, understanding, applications and manipulations of the knowledges of and data on oneself to achieve said objectives. Therefore, said entity is the regulator and controller of its utilizations, expenses, costs of health-cares and health-services thereby is the regulator and controller of operating costs, revenues, incomes impacting on health, quality of life and standard of living.

The system comprises a method of directly modulating, controlling and budgeting the health-care and health-service utilizations and expenses by said entity thereby optimizing said utilizations, expenses by and the returns of said utilizations and expenses to said entity which is a direct consumer-buyer of health-cares, health-services and related procedures, products and services. Since the system relates—by mathetical and statistical means—said health-care and health-service utilizations, expenses and costs to demographics, productivity, impairment, employment and absenteeism characteristics of said entity, consequently, the outcome of the application of said system by said entity is the effects on said entity's health, quality of life, revenues, incomes and standard of living.

Demographics includes gender, age, race, education, compensations, salary, wages, insurances and region of residence, etc. Productivity includes productive time, work days and work hours, etc. Impairment includes inabilities to perform tasks, days and hours of absences from works or worksites, job interruptions, job modifications, sick leaves, etc. Employment includes types of occupations, job types, times and durations on the jobs, etc.

The present invention permits and facilitates the decision making of said entity by presenting and making—instantaneously, continually or otherwise—information, facts and data supra and infra available to and accessible by said entity. Consequently, said entity is able to use, manipulate and permutate said information, facts and data to become the informed health-care and health-service consumer-buyer and, therefore, directly exert control on the issues and matters described herein.

Therefore, according to the method and processes of the present invention, said entitiy uses a process comprises the use of the information on said entity's demographics such as, but not limited to, age, race, and health conditions and illness, disorder or disease henceforth illness. Same entity then uses a process comprises sorting through, finding a match of and comparing said information to a group or series of illnesses, disorders or diseases henceforth illnesses defined by the above criterias presents in, makes available and facilitates by said system to said entity. Consequently, said entity is required with the expert help of said system to either identify and sort the position of his or her demographics, health, illness in a group or series of illnesses or to rank or match said demographics, health and illness in a group or series of illnesses.

The system assigning a first value to an illness, a second value to said illness relating to the health-care and health-service utlizations, expenses and cost, a series of third values to a group of illnesses, a series of fourth values to related, similar or parallel health-cares, health-services, products utlizations, expenses and costs, a series of fifth values to the demographics, productivity, impairment, employment, absenteeism characteristics or any combination thereof of said entity, a sixth value to said illness relating to the health-care and health-service utlizations, expenses and cost and the demographics, productivity, impairment, employment and absenteeism characteristics or any combination thereof of said entity, a seventh series of value to related, similar or parallel health-cares, health-services, products utlizations, expenses and costs relating to the health-care and health-service utlizations, expenses and cost and the demographics, productivity, impairment, employment, absenteeism characteristics or any combination thereof of said entity. The values are such as, but not limited to, economic, monetary, tangible, nontangible values or any combination thereof. Said values and relationships are expressed and represented by mathematical and statistical means.

Using said values and means, said system comprises processes and steps adaptable to decipher and show to said entity an instant expense and cost of a health-care and healthservice, an instant expense and cost of a health-care or health-service and related procedures, products and services, to decipher and show the relative instant expenses and costs of a group of healthcares and healthservices and related procedures, products and services, to decipher and show the instant costs and expenses of health-cares and health-services and related procedures and services used, being used and to be used by said entity, to decipher and show the comparative costs and expenses of health-cares and health-services and related procedures, products and services used, being used and to be used by said entity, to decipher and show the costs and expenses of health-cares and health-services and related procedures, products and services relating to demographics, health, productivity, impairment and employment characteristics of said entity used, being used and to be used by said entity, to decipher and show the comparative costs and expenses of health-cares and health-services and related procedures and services relating to demographics, health, productivity, impairment and employment characteristics of said entity used, being used and to be used by said entity.

The system further deciphers and shows to said entity an instant expense and cost of a health-care and health-service, an instant expense and cost of a health-care, health-service and related procedures, products and services, the relative instant expenses and costs of a group of healthcares, healthservices and related procedures, products and services, the instant costs and expenses of health-cares, health-services and related procedures and services used, being used and to be used by said entity, the comparative costs and expenses of health-cares and health-services, products and related procedures and services used, being used and to be used by said entity, the costs and expenses of health-cares and health-services and related procedures and services relating to said entity's demographics, health, productivity, impairment and employment characteristics used, being used and to be used by said entity; the comparative costs and expenses of health-cares, health-services and related procedures, products and services relating to demographics, health, productivity, impairment and employment characteristics of said entity used, being used and to be used by said entity.

Furthermore, said system comprises processes of tallying said health-care and health-service utilizations, expenses and costs, instant health-care and health-service utilizations, expenses and costs relating to the demographics, health, productivity, impairment and employment characteristics of said entity, the health-care and health-service utilizations, expenses and costs relating to the demographics, health, productivity, impairment and employment characteristics of said entity.

The total effect of said system, consequently, is that said entity is knowledgeable on the information and adept to use said information and data to instantaneously and continually affect and modulate all utilizations, expenses, costs of said health-cares, health-services and related procedures, products and services. Consequently, said entity directly and instantaneously and continually manipulate said costs and expenses, operating costs, expenses, revenues and incomes of oneself by directly and instantaneously and continually manipulate and control one's health-care and health-service purchases and utilizations.

For example, an individual of a certain and unique demographics such as a self-employed male adult having gone hiking in the mountain in New England within the last few weeks has an illness characterized by fever, fatigue and rashes, respectively. With the assistance of said system, said individual going through the processes of said system using said data is adept to sort, relate, rank and match said data in a group of data comprises a group of illnesses. Said person will be granted a most likely match and a diagnosis and alternative but less likely matches and diagnoses. Furthermore, with each dignosis presents by the system to said person, said system relates an instant expense and cost of a health-care or health-service, the relative expenses and costs of other possible diagnoses healthcares and healthservices and related procedures, products and services for other possible diagnoses, the relative expenses and costs of other possible diagnoses healthcares and healthservices and related procedures, products and services for other possible diagnoses used, being used and to be used by said person or other persons of same or similar settings, the comparative costs and expenses of health-cares and health-services, products and related procedures and services used, being used and to be used by said person or other persons of same or similar settings, the costs and expenses of health-cares and health-services and related procedures and services relating to demographics, health, productivity, impairment and absenteeism of said person if same is to use certain healthcares and healthservices and related procedures, products and services, the comparative costs and expenses of health-cares and health-services and related procedures and services relating to demographics, health, productivity, impairment and absenteeism of said person if same is to use alternative healthcares and healthservices and related procedures, products and services relate to other possible diagnoses.

Using mathematical and statistical means, furthermore, the system provides a process whereby an objective means for measuring the health and well-being of said entity as functions of an occurrence, occurences and recurrences of said entity's illness in said entity. The process also measures or gauges the health and well-being of said entity as functions of said health-care and health-service utilizations, costs and expenses and productivity, impairment, employment and absenteeism characteristics, operating costs, expenses, revenues and incomes of said entity.

Using mathematical and statistical means, said system provides a means for measuring and monitoring—a yardstick—wherein said entity can implement an effective and cost-effective system of modulating said entity's health, well-being, health-care and health-service utilizations, costs and expenses and productivities, impairments, employments and absenteeisms, operating costs, expenses, revenues and incomes of said entity. Said system provides the means for measuring the successes of said efforts, endeavors and system. Said system provides the processes for tallying health-care and health-service utilizations, costs and expenses relating to the productivity, impairment, employment and absenteeism characteristics affecting said entity's employment, business, enterprise including operating costs, expenses, revenues and incomes. The results of the application of said system, method, processes are the tallys which can be formatted, appear as or in consolidated statements of expenses or operations, consolidated balance sheets, consolidated statements of changes in equity, earnings and cash flows of said entity.

Although the preferred embodiments have been described, it will be appreciated by those skilled in art that variations, adaptations and applications of the present invention can be had without departing from the spirit of the invention and the scope of the claims.

1. A system of modulating the health-care and health-service utilizations and expenses of an individual or a company by said individual or company henceforth also known as an entity who is a consumer-buyer and a regulator of own's health-care and health-service utilizations, expenses and costs and incomes adaptable to decipher for and show to said entity an expense and cost of a health-care and health-service, to decipher for and show to said entity an expense and cost of a health-care and health-service and related procedures, products and services, to decipher for and show to said entity the relative expenses and costs of a group of health-cares, health-services and related procedures, products and services, to decipher for and show to said entity the costs and expenses of health-cares, health-services and related procedures, products and services used, being used and to be used by said entity, to decipher for and show to said entity the comparative costs and expenses of health-cares and health-services and related procedures, products and services used, being used and to be used by said entity, to decipher for and show to said entity the costs and expenses of health-cares and health-services and related procedures, products and services relating to the demographics, health, productivity, impairment and employment characteristics of said entity and individuals of said company being used and to be used by said entity and said individuals, to decipher for and show to said entity the comparative costs and expenses of health-cares and health-services and related procedures and services relating to the demographics, health, productivity, impairment and employment characteristics of said individual and individuals of said company used, being used and to be used by said entity, consequently, to instantaneously influence the utilizations of health-cares and health-services and related procedures and services by said entity, to influence the health-cares and health-services and related procedures, products and services utilizations by and of said entity, to tally the health-care and health-service utilizations, expenses and costs, to tally the health-care and health-service utilizations, expenses and costs relating to the demographics, health, productivity, impairment and employment characteristics of said individual or the company's individuals, to tally the health-care and health-service utilizations, expenses and costs relating to the demographics, health, productivity, impairment and employment characteristics of said entity, wherein the effects of said system are the direct and instantaneous and continual manipulations of the health-care and health-service utilizations, costs and expenses and the operating costs, expenses, revenues and incomes of said individual or company comprises:
a process of using the information on an individual's demographics;
a process of using the information on an individual's health;
a process of using the information on an individual's illness;
a process of using the information on an individual's illnesses;
a process of sorting an individual's illness relating to a group of illnesses;
a process of using the data on an individual's illness relating to a group of illnesses;
a process of using the data on the productivity, impairment, employment and absenteeism characteristics relating to an illness;
a process of using the data on the productivity, impairment, employment and absenteeism characteristics relating to a group of illnesses;
a process of using the data on an individual's illness relating to a group of demographics and illnesses;
a process of using the data on the productivity, impairment, employment and absenteeism characteristics relating to an individual's demographics, health and illness;
a process of using the data an individual's demographics, health and illness relating to an individual's productivity, impairment, employment and absenteeism characteristics;
a process of using the data an individual's demographics, health and illness relating to individuals' productivity, impairment, employment and absenteeism characteristics;
a process of using the products of the permutations on the productivity, impairment, employment and absenteeism characteristics relating to a group of illnesses;
a process of assigning a value to an illness;
a process of assigning a value to an illness relating to the productivity, impairment, employment and absenteeism characteristics;
a process of assigning a value to an individual's illness relating to the productivity, impairment, employment and absenteeism characteristics;
a process of comparing a series of values of illnesses, symptoms, complaints and signs relating to the productivity, impairment, employment and absenteeism characteristics;
a process of tallying health-care and health-service utilizatins, costs and expenses of an individual's illness;
a process of tallying health-care and health-service utilizatins, costs and expenses of an individual's illnesses;
a process of tallying health-care and health-service utilizatins, costs and expenses of the company of individuals' illnesses;
a process of tallying productivities, impairments, employments and absenteeisms a process of tallying health-care and health-service utilizations, costs and expenses relating to the productivity, impairment, employment and absenteeism characteristics;
a process of tallying health-care and health-service utilizations, costs and expenses relating to the productivity, impairment, employment and absenteeism characteristics of an individual;
a process of tallying health-care and health-service utilizations, costs and expenses relating to the productivity, impairment, employment and absenteeism characteristics of individuals of a company;
a process of tallying health-care and health-service utilizations, costs and expenses relating to the productivity, impairment, employment and absenteeism characteristics and operating costs, expenses, revenues and incomes of an individual;
a process of tallying health-care and health-service utilizations, costs and expenses relating to the productivity, impairment, employment and absenteeism characteristics and operating costs, expenses, revenues and incomes of a company;
a process of measuring the health and well-being of said entity as the functions of the occurrences of said entity's illness;
a process of measuring the health and well-being of said entity as the functions of the recurrences of said entity's illnesses;
a process of measuring the health and well-being of said entity as the functions of said health-care and health-service utilizations, costs and expenses;
a process of measuring the health and well-being of said entity as the functions of productivity, impairment, employment and absenteeism characteristics;
a process of measuring the health and well-being of said entity as the functions of said operating costs, expenses, revenues and incomes of said entity;
a process of measuring the effectiveness of said system of optimizing the utilizations and returns of the health-care and health-service expenses of an individual or a company;
a process of measuring the cost-effectiveness of said system of optimizing the utilizations and returns of the health-care and health-service expenses of an individual or a company;
a process of measuring the effectiveness of said system of optimizing the utilizations and returns of the health-care and health-service expenses of an individual or a company as functions of an occurrence, occurences and recurrences of said entity's illness in an individual or a company;
a process of measuring the effectiveness of said system of optimizing the utilizations and returns of the health-care and health-service expenses of an individual or a company as functions of health-care and health-service utilizations, costs and expenses of said individual or company;
a process of measuring the effectiveness of said system of optimizing the utilizations and returns of the health-care and health-service expenses of an individual or a company as productivity, impairment, employment and absenteeism characteristics, operating costs, expenses, revenues and incomes of said individual or company.

2. A system of optimizing the utilizations and returns of the health-care and health-service expenses of an individual or a company who is a consumer-buyer of the health-cares and health-services and a regulator of own's health-care and health-service utilizations, expenses and costs wherein said utilizations and returns relate to said individual's or company's direct and instantaneous or continual manipulations and adjustments of said health-care and health-service utilizations, costs and expenses adaptable to show an instant expense and cost of a health-care and health-service, to show an instant expense and cost of a health-care or health-service and related procedures and services, to decipher the relative instant expenses and costs of a group of healthcares and healthservices and related procedures and services, to decipher the instant costs and expenses of health-cares and health-services and related procedures and services used, being used and to be used by said consumer-buyer and regulator, to decipher the comparative costs and expenses of health-cares and health-services and related procedures and services used, being used and to be used by said consumer-buyer and regulator, to decipher the costs and expenses of health-cares and health-services and related procedures and services relating to demographics, health, productivity, impairment and employment characteristics of said individual or company's individuals used, being used and to be used by said consumer-buyer and regulator, to decipher the comparative costs and expenses of health-cares and health-services and related procedures and services relating to demographics, health, productivity, impairment and employment characteristics of said individual or company's individuals used, being used and to be used by said consumer-buyer and regulator, consequently, to instantaneously influence the utilizations of health-cares and health-services and related procedures and services by said consumer-buyer and regulator, to influence the health-cares and health-services and related procedures and services utilizations by and of said consumer-buyer and regulator, to tally the health-care and health-service utilizations, expenses and costs, to tally the instant health-care and health-service utilizations, expenses and costs relating to the demographics, health, productivity, impairment and employment characteristics of said individual or the company's individuals, to tally the health-care and health-service utilizations, expenses and costs relating to the demographics, health, productivity, impairment and employment characteristics of said individual or company wherein said method affects the operating costs, expenses, revenues and incomes of said individual or company comprises:
a process of using the information on an individual's demographics;
a process of using the information on an individual's health;
a process of using the information on an individual's illness;
a process of using the information on an individual's illnesses;
a process of sorting an individual's illness relating to a group of illnesses;
a process of using the data on an individual's illness relating to a group of illnesses;
a process of using the data on the productivity, impairment, employment and absenteeism characteristics relating to an illness;
a process of using the data on the productivity, impairment, employment and absenteeism characteristics relating to a group of illnesses;
a process of using the data on an individual's illness, symptoms, complaints and signs relating to a group of demographics, illnesses;
a process of using the data on the productivity, impairment, employment and absenteeism characteristics relating to an individual's demographics, health and illness;
a process of using the data an individual's demographics, health and illness relating to an individual's productivity, impairment, employment and absenteeism characteristics;
a process of using the data an individual's demographics, health and illness relating to individuals' productivity, impairment, employment and absenteeism characteristics;
a process of using the products of the permutations on the productivity, impairment, employment and absenteeism characteristics relating to a group of illnesses;
a process of assigning a value to an illness;
a process of assigning a value to an illness relating to the productivity, impairment, employment and absenteeism characteristics;
a process of assigning a value to an individual's illness relating to the productivity, impairment, employment and absenteeism characteristics;
a process of comparing a series of values of illnesses relating to the productivity, impairment, employment and absenteeism characteristics;
a process of tallying health-care and health-service utilizatins, costs and expenses of an individual's illness;
a process of tallying health-care and health-service utilizatins, costs and expenses of an individual's illnesses;
a process of tallying health-care and health-service utilizatins, costs and expenses of the company of individuals' illnesses;
a process of tallying productivities, impairments, employments and absenteeisms a process of tallying health-care and health-service utilizations, costs and expenses relating to the productivity, impairment, employment and absenteeism characteristics;
a process of tallying health-care and health-service utilizations, costs and expenses relating to the productivity, impairment, employment and absenteeism characteristics of an individual;
a process of tallying health-care and health-service utilizations, costs and expenses relating to the productivity, impairment, employment and absenteeism characteristics of individuals of a company;
a process of tallying health-care and health-service utilizations, costs and expenses relating to the productivity, impairment, employment and absenteeism characteristics and operating costs, expenses, revenues and incomes of an individual;
a process of tallying health-care and health-service utilizations, costs and expenses relating to the productivity, impairment, employment and absenteeism characteristics and operating costs, expenses, revenues and incomes of a company;
a process of measuring the health and well-being of said entity as the functions of the occurrences of said entity's illness;
a process of measuring the health and well-being of said entity as the functions of the recurrences of said entity's illnesses;
a process of measuring the health and well-being of said entity as the functions of said health-care and health-service utilizations, costs and expenses;
a process of measuring the health and well-being of said entity as the functions of productivity, impairment, employment and absenteeism characteristics;
a process of measuring the health and well-being of said entity as the functions of said operating costs, expenses, revenues and incomes of said entity;
a process of measuring the effectiveness of said system of optimizing the utilizations and returns of the health-care and health-service expenses of an individual or a company;
a process of measuring the cost-effectiveness of said system of optimizing the utilizations and returns of the health-care and health-service expenses of an individual or a company;
a process of measuring the effectiveness of said system of optimizing the utilizations and returns of the health-care and health-service expenses of an individual or a company as the functions of an occurrence, occurences and recurrences of said entity's illness in an individual or a company;
a process of measuring the effectiveness of said system of optimizing the utilizations and returns of the health-care and health-service expenses of an individual or a company as the functions of health-care and health-service utilizations, costs and expenses of said individual or company; and
a process of measuring the effectiveness of said system of optimizing the utilizations and returns of the health-care and health-service expenses of an individual or a company as productivity, impairment, employment and absenteeism characteristics, operating costs, expenses, revenues and incomes of said individual or company.

3. A method of modulating the health-care and health-service utilizations and expenses of an individual or a company wherein said individual or company is a consumer-buyer and a regulator of own's health-care and health-service utilizations, expenses and costs and incomes adaptable to measure and show the effectiveness and cost-effective of a health-care and health-service, to show an instant expense and cost of a health-care and health-service, to show an instant expense and cost of a health-care or health-service and related procedures and services, to decipher the relative instant expenses and costs of a group of healthcares and healthservices and related procedures and services, to decipher the instant costs and expenses of health-cares and health-services and related procedures and services used, being used and to be used by said consumer-buyer and regulator, to decipher the comparative costs and expenses of health-cares and health-services and related procedures and services used, being used and to be used by said consumer-buyer and regulator, to decipher the costs and expenses of health-cares and health-services and related procedures and services relating to demographics, health, productivity, impairment and employment characteristics of said individual or company's individuals used, being used and to be used by said consumer-buyer and regulator, to decipher the comparative costs and expenses of health-cares and health-services and related procedures and services relating to demographics, health, productivity, impairment and employment characteristics of said individual or company's individuals used, being used and to be used by said consumer-buyer and regulator, consequently, to instantaneously influence the utilizations of health-cares and health-services and related procedures and services by said consumer-buyer and regulator, to influence the health-cares and health-services and related procedures and services utilizations by and of said consumer-buyer and regulator, to tally the health-care and health-service utilizations, expenses and costs, to tally the instant health-care and health-service utilizations, expenses and costs relating to the demographics, health, productivity, impairment and employment characteristics of said individual or the company's individuals, to tally the health-care and health-service utilizations, expenses and costs relating to the demographics, health, productivity, impairment and employment characteristics of said individual or company, wherein the effects of said method are the direct and instantaneous or continual manipulations of the health-care and health-service utilizations, costs and expenses and the operating costs, expenses, revenues and incomes of said individual or company comprises:
a process of using the information on an individual's demographics;
a process of using the information on an individual's health;
a process of using the information on an individual's illness;
a process of using the information on an individual's illnesses;
a process of sorting an individual's illness relating to a group of illnesses;
a process of using the data on an individual's illness, symptoms, complaints and signs relating to a group of illnesses;
a process of using the data on the productivity, impairment, employment and absenteeism characteristics relating to an illness;
a process of using the data on the productivity, impairment, employment and absenteeism characteristics relating to a group of illnesses;
a process of using the data on an individual's illness, symptoms, complaints and signs relating to a group of demographics and illnesses;
a process of using the data on the productivity, impairment, employment and absenteeism characteristics relating to an individual's demographics, health and illness;
a process of using the data an individual's demographics, health and illness relating to an individual's productivity, impairment, employment and absenteeism characteristics;
a process of using the data an individual's demographics, health and illness relating to individuals' productivity, impairment, employment and absenteeism characteristics;
a process of using the products of the permutations on the productivity, impairment, employment and absenteeism characteristics relating to a group of illnesses;
a process of assigning a value to an illness;
a process of assigning a value to an illness relating to the productivity, impairment, employment and absenteeism characteristics;
a process of assigning a value to an individual's illness relating to the productivity, impairment, employment and absenteeism characteristics;
a process of comparing a series of values of illnesses relating to the productivity, impairment, employment and absenteeism characteristics;
a process of tallying health-care and health-service utilizatins, costs and expenses of an individual's illness;
a process of tallying health-care and health-service utilizatins, costs and expenses of an individual's illnesses;
a process of tallying health-care and health-service utilizatins, costs and expenses of the company of individuals' illnesses;
a process of tallying productivities, impairments, employments and absenteeisms a process of tallying health-care and health-service utilizations, costs and expenses relating to the productivity, impairment, employment and absenteeism characteristics;
a process of tallying health-care and health-service utilizations, costs and expenses relating to the productivity, impairment, employment and absenteeism characteristics of an individual;
a process of tallying health-care and health-service utilizations, costs and expenses relating to the productivity, impairment, employment and absenteeism characteristics of individuals of a company;
a process of tallying health-care and health-service utilizations, costs and expenses relating to the productivity, impairment, employment and absenteeism characteristics and operating costs, expenses, revenues and incomes of an individual;
a process of tallying health-care and health-service utilizations, costs and expenses relating to the productivity, impairment, employment and absenteeism characteristics and operating costs, expenses, revenues and incomes of a company;
a process of measuring the health and well-being of said entity as the functions of the occurrences of said entity's illness;
a process of measuring the health and well-being of said entity as the functions of the recurrences of said entity's illnesses;
a process of measuring the health and well-being of said entity as the functions of said health-care and health-service utilizations, costs and expenses;
a process of measuring the health and well-being of said entity as the functions of productivity, impairment, employment and absenteeism characteristics;
a process of measuring the health and well-being of said entity as the functions of said operating costs, expenses, revenues and incomes of said entity;
a process of measuring the effectiveness of said system of optimizing the utilizations and returns of the health-care and health-service expenses of an individual or a company;
a process of measuring the cost-effectiveness of said system of optimizing the utilizations and returns of the health-care and health-service expenses of an individual or a company;
a process of measuring the effectiveness of said system of optimizing the utilizations and returns of the health-care and health-service expenses of an individual or a company as the functions of an occurrence, occurences and recurrences of said entity's illness in an individual or a company;
a process of measuring the effectiveness of said system of optimizing the utilizations and returns of the health-care and health-service expenses of an individual or a company as the functions of health-care and health-service utilizations, costs and expenses of said individual or company; and
a process of measuring the effectiveness of said system of optimizing the utilizations and returns of the health-care and health-service expenses of an individual or a company as productivity, impairment, employment and absenteeism characteristics, operating costs, expenses, revenues and incomes of said individual or company.
